(19) United States
(12) Patent Application Publication
(10) Pub. No.: US 2003/0051251 A1
(43) Pub. Date: Mar. 13, 2003

(54) System and apparatus for supplying audiovisual information to a subscriber terminal

(75) Inventors: Masao Sugimoto, Tokyo (JP); Osamu Tazawa, Tokyo (JP); Takashi Okano, Tokyo (JP); Munehiko Iwase, Tokyo (JP)

Correspondence Address: McGinn & Gibb, PLLC, Suite 200, 8321 Old Courthouse Road, Vienna, VA, 22182-3817, US

(73) Assignee: Pioneer Corporation, Tokyo (JP)

(21) Appl. No.: 10/237,725

(22) Filed: Sep. 10, 2002

(30) Foreign Application Priority Data
Sep. 12, 2001 (JP) 2001-277001

(51) Int. Cl. H04N 7/173; G06F 15/16

(52) U.S. Cl. 725/95; 725/114; 709/219

(57) ABSTRACT

A system and apparatus for transmitting audio and video information to one or more subscribers terminal from a server. Each subscriber terminal includes a storage unit. The server selects an information distribution scheme (unicast or multicast) and sends the information to the subscriber terminal(s). Each subscriber terminal receives the information in accordance with the selected information distribution scheme, and stores the information in the storage unit. The system can cope with multiple requests from the subscribers without increasing the VOD service cost.

### BACKGROUND OF THE INVENTION

1. Field of the Invention

The present invention relates to a system and apparatus for providing a subscriber terminal with audiovisual information such as movies, music and news.

2. Description of the Related Art

A conventional telephone line can only deliver data (information) at some 32 Kbps. Instead of the telephone line, a broadband transmission (communication) technology has been developed and utilized today, which has data transmission capability of 1 Mbps or more. The broadband transmission technology enables exchange of large quantities of multimedia information, and is prevalent even in residences. Broadband communication has a wide variety of schemes. One scheme is a DSL (digital subscriber line), which uses a copper line of a conventional telephone line. Another scheme establishes an Internet-exclusive channel in an existing CATV (community antenna television or cable television) network. Still another scheme utilizes an optical cable connection to a residence.

Theoretically, use of the broadband communication technology can provide a VOD (video on-demand) service, which promptly distributes audio and video information to a subscriber in response to a request from the subscriber. Recently, the VOD is commercially practiced using a satellite broadcasting channel. In many instances, however, the NVOD (near video on-demand) is used. In the NVOD, the same content (e.g., movie) is distributed to a number of channels at, for example, 30-minute intervals so that a subscriber can watch the movie from the beginning on a certain channel if the subscriber waits 30 minutes at most. However, the NVOD requires a huge number of channels. Otherwise, the subscriber has to wait longer.

If the broadband transmission including a channel having a transmission rate of 10 Mbps or more is used, a true VOD is achieved, i.e., the content is delivered to a subscriber in an on-demand manner upon a request from the subscriber. For example, if audio and video information compressed by an MPEG (moving picture experts group)-2 method is transmitted to a subscriber's terminal from a VOD system at a data transmission rate of 4.5 Mbps, the compressed information is decoded and reproduced at the subscriber terminal on a real-time basis at high quality.

The VOD system is designed to send movies, TV programs and other information to subscribers in response to requests from the subscribers. If the VOD system receives many requests in a short period and tries to transmit the information to all of the requesting subscribers in real-time, the VOD system has to have a very large transmission capacity. This increases the cost for VOD facilities and VOD services.

### SUMMARY OF THE INVENTION

An object of the present invention is to provide an audio and video information providing system that can cope with a deluge of requests from subscribers without increasing the VOD service cost.

According to one aspect of the present invention, there is provided a system for providing one or more subscriber terminals with information comprising: at least one subscriber terminal, each having a storage unit; and a server for selecting a unicast scheme or a multicast scheme and sending information to the at least one subscriber terminal in the selected scheme, wherein each subscriber terminal receives the information in a manner complying with the selected scheme and stores the information in the storage unit. The information may be audiovisual information, and the storage unit may be a write once type or rewritable type. The multicast scheme or unicast scheme is selected in accordance with a content of the information to be distributed. Therefore, it is possible to efficiently utilize channels and provide the subscriber(s) with a VOD service at low cost.

### BRIEF DESCRIPTION OF THE DRAWINGS

FIG. 1 illustrates a block diagram of an audio and video information providing system according to one embodiment of the present invention;

FIG. 2 illustrates a block diagram of a subscriber terminal (STB) shown in FIG. 1;

FIG. 3 illustrates frequency bands for signals transmitted in a CATV network inside the audio and video information providing system shown in FIG. 1;

FIG. 4 illustrates a conceptual diagram of a pre-loading service;

FIG. 5 illustrates a conceptual diagram of a multicast and unicast distribution;

FIG. 6 illustrates a flowchart of an operation of a head end shown in FIG. 1; and

FIG. 7 illustrates a flowchart of an operation of the subscriber terminal shown in FIG. 1.

### DETAILED DESCRIPTION OF THE INVENTION

An embodiment of the present invention will be described with reference to the accompanying drawings.

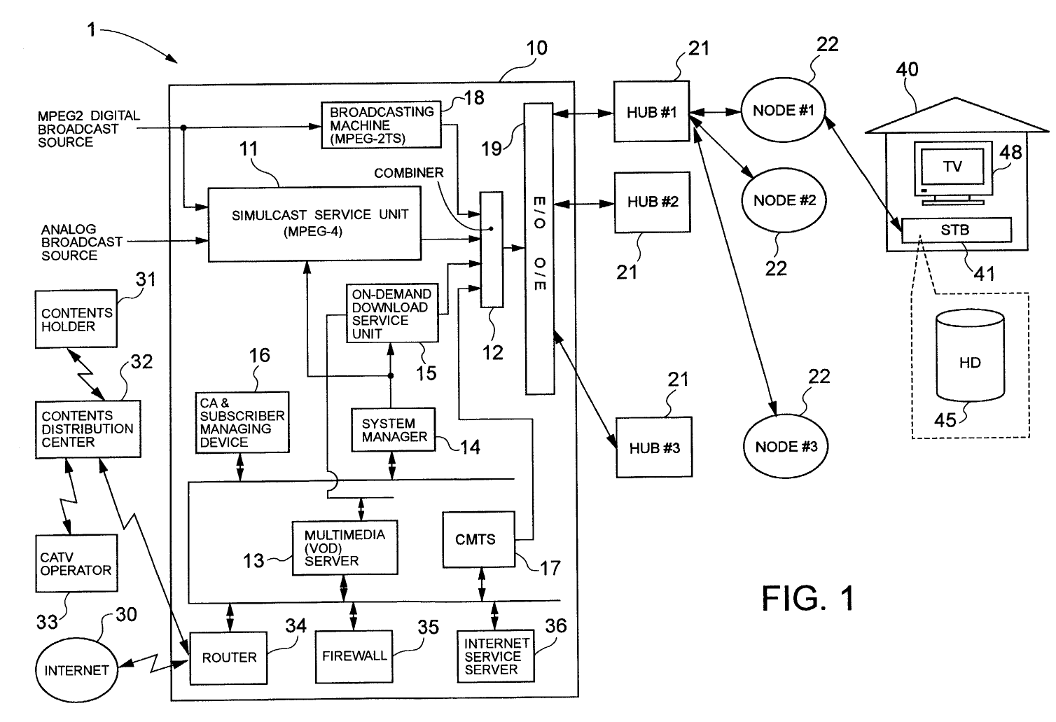

Referring to FIG. 1, an overall construction of an audiovisual information providing system 1 according to one embodiment of the present invention is illustrated.

In the information providing system 1, a plurality of subscriber terminals (STB) 41 in a plurality of subscriber facilities 40 are connected to a head end 10 via a plurality of hubs 21 and a plurality of nodes 22 respectively. The head end 10, hubs 21 and nodes 22 constitute a CATV network. It should be noted that the CATV network may include more than one head end 10 although the drawing illustrates a single head end. The CATV network provides pathways to transmit information (contents) such as images, pictures, sound and music to the STBs 41 through optical fibers or copper wires.

Each STB 41 is a television adapter (TV adapter), which is sometimes called “settop box”. The STB 41 is coupled to a television set (TV) 48 which can reproduce analog or digital images (picture, video) and sound (music, voice) signals. The STB 41 also serves as a computer terminal which has a communication function and a multimedia function. The STB 41 has a hard disc (HD) 45, which is a write once or rewritable type storage device, to store software necessary for the STB 41 to function as a computer. Information obtained by the STB 41 is also stored in the HD 45. Each STB 41 may have a self-diagnosis function and inform the head end 10 of a diagnosis result.

The head end 10 is an audio and video information server to cover a certain area of the CATV network. A number of subscribers can subscribe to the head end 10. In case of large-scale CATV network, a plurality of head ends 10 may be established in a hierarchical structure. The head end 10 collects contents from outside (e.g., pay digital broadcast source of MPEG2 type or free analog broadcast source) via a wireless hookup antenna (not shown). These contents or signals undergo high-efficiency compression by a broadcast (MPEG2TS) device 18 and are multiplexed for respective channels by a synthesizing unit (combiner) 12. The multiplexed signals are modulated by a modulation and demodulation device 19 and transmitted to the subscribers. It should be noted that a simulcast (MPEG-4) unit may be employed instead of the broadcast device 18 to provide high-efficiency compressed signals.

The head end 10 also has a function to collect and distribute pay-for-view contents such as movies. These contents are first collected by a content distribution center 32 from a content holder 31 such as a movie company, and then transferred to the head end 10 from the distribution center 32 upon instructions from a CATV operator 33. The transferring of the contents to the head end 10 is carried out through an ordinary telephone line or an exclusive-use line at a relatively slow speed. Inside the head end 10, the contents are transmitted to a multimedia (VOD) server 13 via a router 34 and a firewall 35, and accumulated in the multimedia server 13.

The head end 10 is also able to connect to the Internet 30. Specifically, an Internet service server 36 connects to the Internet 30 via the router 34 and firewall 35. The Internet service server 36 communicates with the STB 41 through a DOCSIS (data over cable service interface specification) channel. The DOCSIS channel is accompanied with a CMTS (cable modem terminal system) 17, the combiner 12 which performs the multiplexing and demultiplexing, and the modulation and demodulation unit 19 which performs the modulation and demodulation.

A system manager 14 is a control unit for controlling overall services provided to each of the subscriber facilities. The system manager 14 is connected to a CA (conditional access) and subscriber managing device 16, the multimedia server 13, CMTS 17, Internet service server 36, firewall 35 and router 34 via a local network inside the head end 10 such that the system manager 14 can control these elements. The system manager 14 uses the CA and subscriber managing device 16 to perform a managing operation such as subscriber authentication and service class identification (confirmation) upon connection of the STB 41 to the head end 10.

The system manager 14 uses an on-demand download service unit 15 to control an operation in response to a content distribution request from the STB 41 on an on-demand basis. Specifically, the system manager 14 accepts the distribution request and performs an initialization setting before distribution; the system manager 14 retrieves a content requested, selects a vacant channel for content distribution and informs the STB 41 of the selected channel. Under the control of the system manager 14, the on-demand download service unit 15 controls the multimedia server 13 to read (retrieve) the requested content, the combiner 12 to multiplex the content for the selected channel, and the modulation and demodulation unit 19 to modulate the content before distributing the content to the STB 41. Control signals used in the pre-distribution setting may be sent over the DOCSIS channel.

The system manager 14 is also able to pre-load contents to the STBs 41. Specifically, the system manager 14 distributes certain contents (e.g., popular titles) to the STBs 41 in advance on the assumption that the subscribers like or will request these contents. It is expected that about 90% of the subscribers who are interested in movies want to have the same popular movie(s) distributed, or about 90% of the requests from the subscribers are directed to the same popular movie(s). By pre-loading (distributing in advance) these popular contents to the STBs 41 in a limited amount, the load on the overall system is smoothed over time. The pre-loading operation is performed under the control of the system manager 14 such that the contents are distributed to the STBs 41 from the multimedia server 13 via the Internet channel. Because conflict occurs between use of the Internet channel for the normal Internet operation via the DOCSIS channel and use of the Internet channel for the pre-loading, the pre-loading operation is carried out when there is only a small amount of or no traffic in the Internet channel. The system manager 14 may monitor the traffic on the Internet 30.

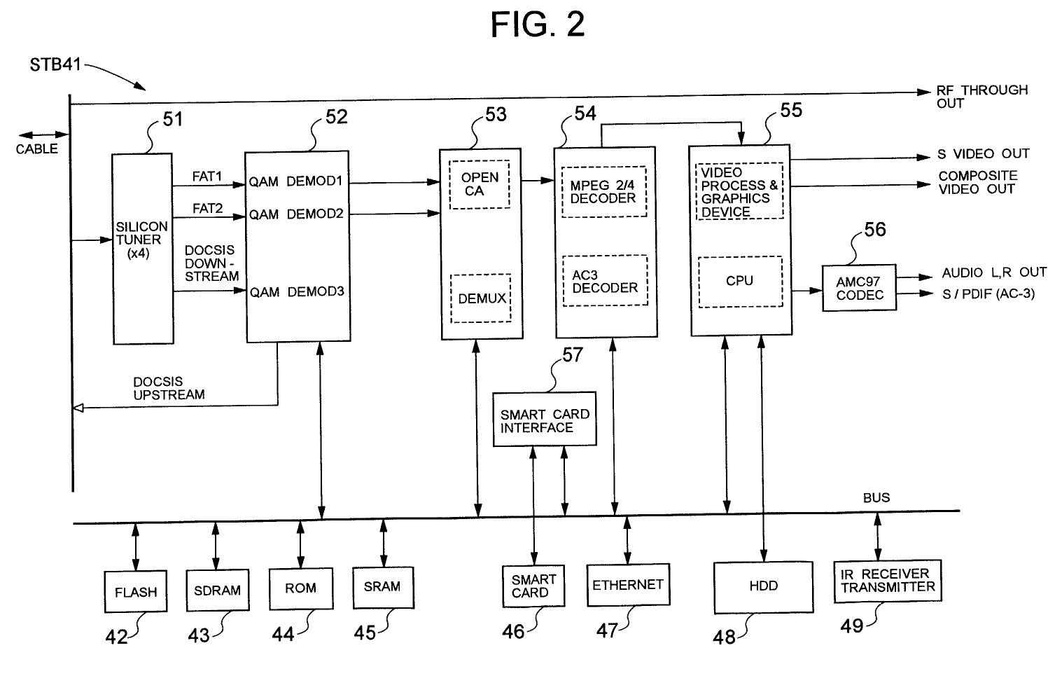

Referring to FIG. 2, the detail of the STB 41 shown in FIG. 1 is illustrated.

A FLASH 42, SDRAM 43, ROM 44 and SRAM 48 are memories connected to a common bus. A smart card interface 57, an Ethernet card 47 and an infrared receiver and transmitter 49 are peripheral equipment and also connected to the bus. The peripheral equipment is controlled by a main processor 55, which includes a CPU and an image processing unit, and constitute a computerized machine. The hard disc 45 is directly coupled with the main processor 55 so that data input and output at a high speed (e.g., DMA; directly memory access), is possible. Data exchange between the STB 41 and outside is permitted through the smart card 46 and smart card interface 57.

A signal coming into the STB 41 via the cable is simply transmitted as a passing signal (RF through out). The same incoming signal is tuned at a plurality of frequency channels by a silicon tuner 51, and the respective outputs are introduced to a QAM demodulator 52 and demodulated. The resulting signals are demultiplexed by a demultiplexer 53. Setting for CA (conditional access) such as machine number authentication of the STB 41 is also conducted in the demultiplexer 53. The output signal of the demultiplexing unit 53 is supplied to a decoder 54 such that the signal is decoded by the MPEG-2 or MPEG-4 decoding method. The acoustic information is decoded by, for example, the AC3 decoding method for Dolby surround processing. The dynamic picture signal resulting from the decoder 54 is converted to an ordinary digital or analog TV image (picture, video) signal by an image and graphics processing unit in the main processor 55, and output (S video out, composite video out). The acoustic signal is interfaced by an AMC97 codec 56 in a standard way and output (audio L, R out, S/PDIF(AC-3)).

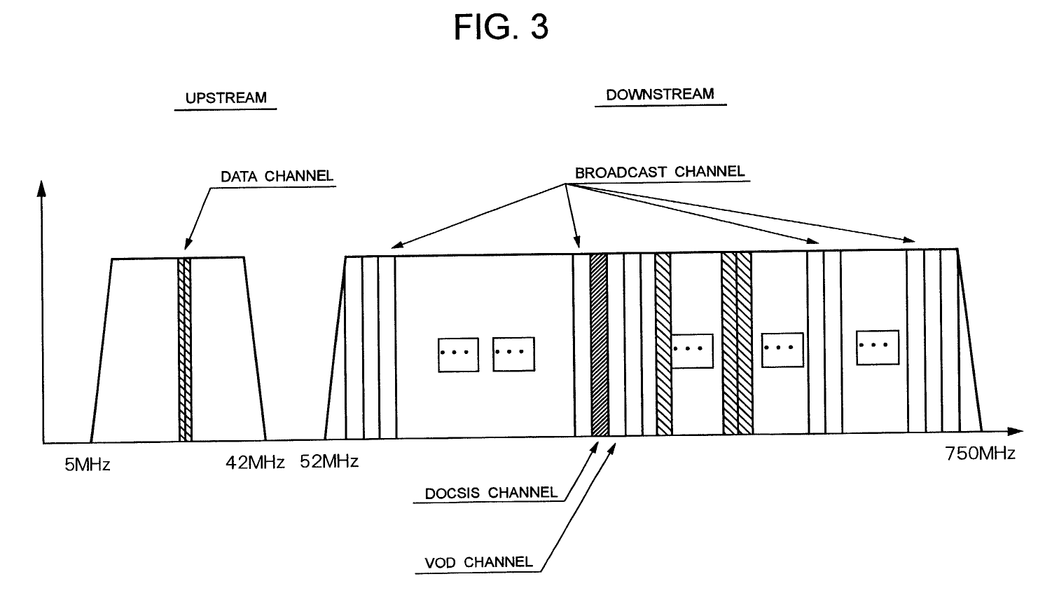

Referring to FIG. 3, frequency bandwidths allotted to channels for cable signals transmitted between the head end 10 and STB 41 are illustrated. The signals include upstream signals, which are directed to the head end 10, and downstream signals, which are directed to the STB 41. One of the channels for the upstream signals is a data channel. Some of the downstream signal channels are ordinary broadcast channels, one of the downstream signal channels is the DOCSIS (data over cable service interface specification) channel, and one of the downstream signal channels is a VOD channel. The channel allotting is determined in accordance with types of the audio and video information. The types of the information are, for example, movies, TV programs, merchandise catalogs, and navigation information. The channel allotting may also be decided in further consideration of an information distributing time or period, an area or location of the STB 41, and a service class. The DOCSIS channel is a data transmission channel in compliance with a standardization rule (code) of data communication decided by a cable modem. In this embodiment, the DOCSIS channel is used to authenticate connection between the head end 10 and the STB 41, decide parameters, detect a service class and exchange the channel allocation information. The DOCSIS channel is also used for the ordinary Internet communication. Further, the DOCSIS channel is utilized for the pre-loading of particular contents. On the other hand, the VOD channel is used to distribute general contents on an on-demand basis. For instance, audiovisual contents compressed by the MPEG-4 method can be transmitted at a relatively low bit rate (e.g., 1.2 to 1.5 Mbps in average) if VBR (variable bit rate) technique and numerical multiplexing scheme are used for high-efficiency transmission. Therefore, if a transmission channel having a transmission capacity of 32 Mbps/channel is used, this channel can simultaneously distribute a plurality of titles to each of the STBs 41 through twenty-four to thirty sub-channels. In the illustrated embodiment, the VOD distribution is carried out in response to a request from a subscriber such that one of the sub-channels is allotted to that subscriber's terminal.

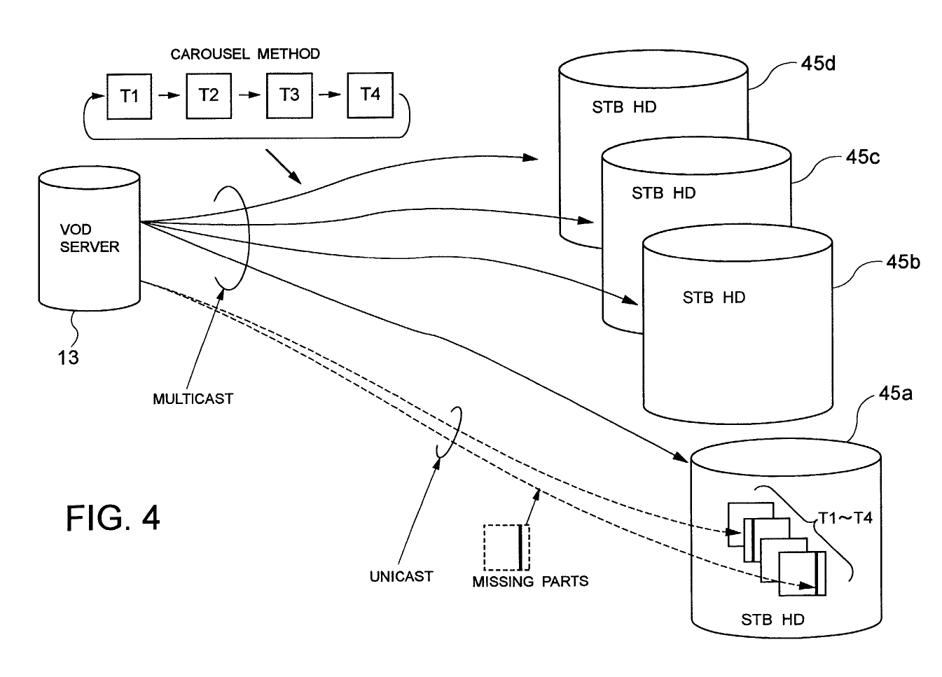

Referring now to FIG. 4, an example of the pre-loading (in-advance distribution) is depicted. The VOD (multimedia) server 13 distributes information (e.g., a plurality of titles) to a plurality of hard discs (HDs) 45a to 45d of a plurality of subscribers (STBs) 41 in a multicast manner. The titles are transmitted in a cyclic manner by a carousel method or a showcase method. This allows the STBs 41 to receive and accumulate all the titles successively even if the STBs 41 are randomly brought into an activated condition. When a title is distributed by the carousel method, however, part of the title may be lost or damaged under a certain communication condition during the distribution. In the illustrated example, two of four titles in the HD 45a have missing parts, and the VOD server 13 transmits the corresponding parts to the HD 45a in a unicast manner.

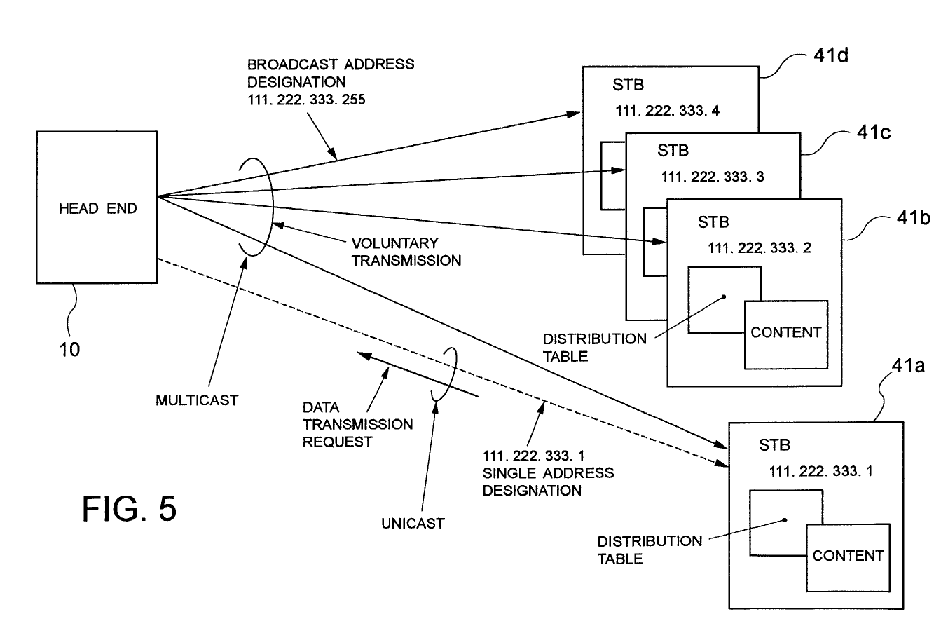

FIG. 5 illustrates data distribution in the multicast manner and unicast manner. The head end 10 performs the multicast to a plurality of STBs 41a to 41d using broadcast addresses. If the illustrated example operates on an IP protocol, the head end 10 broadcasts the same information to all terminals which belong to a domain “111.222.333” when “255” is input at the end of the address. In general, the multicast is utilized when the head end 10 voluntarily distributes the information to a plurality of STBs 41. On the other hand, when the address “111.222.333.1” is input to specify a destination node, the head end 10 transmits the information to the STB 41a only. This is the unicast mode. In general, the unicast mode is utilized when the head end 10 sends the information in response to a data transmission request from a particular STB 41. Therefore, the multicast mode is used to simultaneously send one or more certain (predetermined) titles to a plurality of the STBs for the pre-loading, and the unicast mode is used to send a complementary part of information when the delivered information is incomplete.

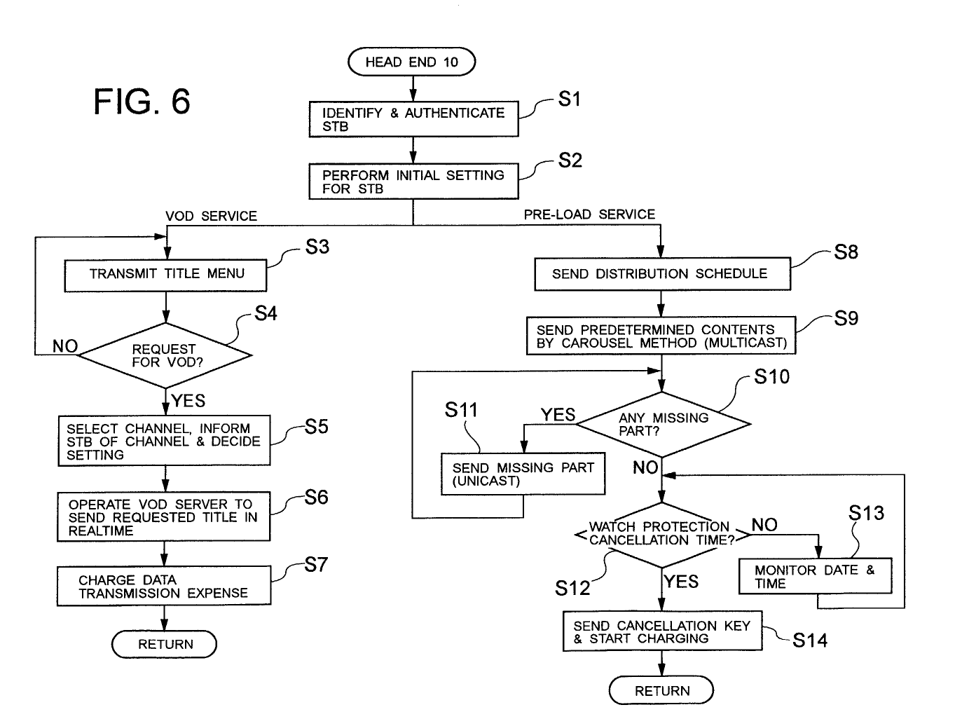

FIG. 6 illustrates an operation of the head end 10 of the audio and video information providing system 1. The following description deals with the head end 10 which distributes information to a newly activated STB 41.

Firstly, the head end 10 identifies and authenticates the STB 41 (Step S1). Specifically, the head end 10 determines whether the activated STB 41 is a terminal of a registered subscriber (subscriber authentication), and identifies a service class on the basis of the subscriber identification information. The authentication method, i.e., the method for a CA (conditional access) control, is for example a method defined in accordance with ISO 7816-1, 2, 3 or 4. For instance, the head end 10 authenticates whether the subscriber in question is the registered subscriber on the basis of a machine identification information of the STB 41 such as MAC (media access control) address, and detects the service class of the subscriber. The service class may include indication of broadcast channels to be provided to the subscriber, availability of VOD service, and availability of pre-load service. The service class may also include genres of contents to be distributed in the pre-load distribution in accordance with subscriber's preference.

The head end 10 applies the initial setting to the STB 41 (Step S2). Specifically, the head end 10 decides necessary parameters to the STB 41 on the basis of the results of the subscriber authentication and identification. One of such parameters relates to frequencies allotted to the channels to be offered. The channels to be offered are decided in accordance with contents to be distributed, area of the subscriber and/or time of distribution. Information exchange for the initial setting is effected in a bidirectional manner via the DOCSIS channel and/or the data channel on the upstream side (FIG. 3).

Subsequently, the VOD service and pre-load service are performed in parallel at the same time a normal broadcast service (not shown) is performed.

In the VOD service, the head end 10 sends a title menu to the STB 41 (Step S3) and waits for a watch request from the subscriber (Step S4). The title menu may include a list of movies together with their introduction information. When the head end 10 receives a watch request (VOD request) from the subscriber which specifies a particular title, the head end 10 selects a channel for transmission of this title, notifies the STB 41 of the selected channel and performs the setting (Step S5). After that, the head end 10 controls the VOD server to operate such that the requested title is distributed to the STB 41 in realtime (Step S6). If necessary, the head end 10 performs an expense calculation and charges for the VOD service (Step S7).

In the pre-load service, the head end 10 transmits a distribution schedule to the STB 41 (Step S8). The transmission of the distribution schedule is decided on the basis of a monitored amount of traffic in the DOCSIS channel which is used for the pre-load distribution. Since the DOCSIS channel is generally used for exchange of control and setting information between the head end 10 and STB 41 as well as for Internet data communication between the subscriber and Internet, the head end 10 decides when and in how much volume (transmission rate) the pre-loading can be performed without hindering the smooth traffic in the DOCSIS channel.

Based on this schedule, the head end 10 sends predetermined contents, e.g., popular titles, to all STBs 41 which are entitled to the pre-load service in a multicast manner (Step S9). The titles are distributed by the carousel method (FIG. 4). Some or all of the titles may be updated to most recent titles at predetermined intervals. For example, the top ten popular titles for this week will be entirely updated each week.

The head end 10 checks the result of simultaneous (multicast) distribution and determines whether there is any incomplete data (Step S10). The data may become incomplete due to a transmission error such as communication interruption (disconnection). Presence of the incomplete data may be determined on the basis of a request from a STB 41 which requests transmission of a missing part of the data. If the head end 10 receives such request, the head end 10 transmits the missing part to the hard disc 45 of that STB 41 in the unicast manner (Step S11).

In the pre-loading operation, therefore, a plurality of titles are automatically stored in the hard disc 45 of the STB 41 without intervention of the subscriber. It should be noted, however, that a certain title may be prohibited (protected) from being watched by the public, including the subscriber, because that title is scheduled to be released some days or weeks later. In this case, the subscriber cannot watch that title upon distribution. The head end 10 will send a release key (cancellation key or authorization key) to the STB 41 at an appropriate time to permit the subscriber to watch that title (or to cancel the watch protection).

To this end, the head end 10 determines whether the present date and time correspond cancellation date and time of the watch protection with respect to each of the titles (Step S12). If the present date and time are prior to the watch protection cancellation date and time with respect to a title in question, the head end 10 continues to monitor the date and time (Step S13). If the present date and time correspond to the watch protection cancellation date and time for that title, the head end 10 transmits the cancellation key to the STB 41, and starts the fee calculating operation if necessary (Step S14).

There may be a plurality of ways to prohibit the watching of the title and cancel the watch prohibition. For instance, encryption technology is used such that the title is encrypted and sent to the STB 41, and a decryption key for the encrypted title is later sent to the STB 41 as the protection cancellation key.

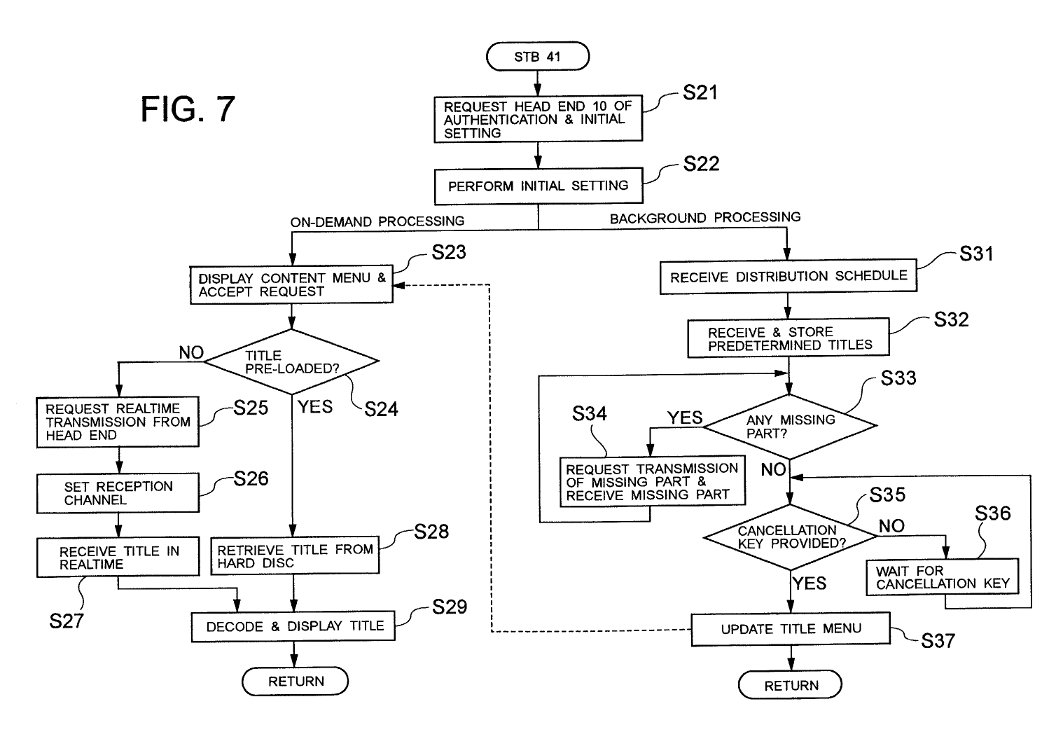

Referring to FIG. 7, an operation of the STB 41 in the audio and video information providing system 1 is described. Particularly the following description deals with the operation of the STB 41 in conjunction with the head end 10 when the STB 41 is activated.

Firstly, the STB 41 issues an authentication request and an initial setting request to the head end 10 when the STB 41 is connected to the head end 10 (Step S21). In response to these requests, setting parameters and other data and information are transmitted to the STB 41 from the head end 10 so that the initial setting is performed to the STB 41 (Step S22). As a result, the STB 41 is activated and has necessary parameters for channel allocation and the like. During or after the initial setting, the remaining capacity of the hard disc 45 of the STB 41 and/or the non-malfunctioning of the STB 41 and associated equipment may be checked autonomically (self diagnosis function) or upon instructions from the head end 10.

Subsequently, on-demand processing and background processing are carried out in parallel to an ordinary broadcast service (not shown).

The on-demand processing (use of the VOD service) is described first. The STB 41 displays a content menu, which is transmitted from the head end 10, to accept a watch request from the subscriber (Step S23). The STB 41 then determines whether the requested content (title) has been loaded by the pre-loading operation (Step S24). If the title has not been pre-loaded, i.e., if the title is not a popular title, the STB 41 requests the head end 10 to transmit the title in realtime (Step S25). In response to this request, the head end 10 selects a channel and decides various conditions, and the STB 41 establishes the channel on the basis of the conditions (Step S26). The STB 41 then receives the title in realtime (Step S27). If, on the other hand, the desired title is already pre-loaded, i.e., the title is a popular title, the STB 41 reads (retrieves) the title from the hard disc 45 (Step S28). The STB 41 decodes the title, which is coded by the MPEG-4 method or the like, in realtime and displays the decoded title on a television 48 (Step S29).

Next, the background processing (use of the pre-load service) is described. Basically, the pre-load service is automatically executed under the control of the head end 10, regardless of intention of the subscriber. The STB 41 receives the distribution schedule from the head end 10 and stores the distribution schedule in the form of a distribution table (Step S31). The STB 41 successively receives title contents from the head end 10 in accordance with the distribution schedule and accumulates the title contents in the hard disc 45 (Step S32).

The STB 41 then determines whether any of the distributed contents have missing data (Step S33). If a certain content has a missing part, the STB 41 requests the head end 10 of the missing part to obtain the missing part (Step S34). In this manner, the STB 41 performs the anticipated downloading of particular contents as an underground process. The subscriber is not conscious of this underground process. Therefore, use of the Internet and ordinary VOD service is not hindered by the pre-loading process. In other words, the display function and operability of the STB 41 are not adversely affected by the pre-loading process.

The STB 41 does not immediately indicate all the contents stored in the hard disc 45 in the title menu. The STB 41 rather waits for watch-protection cancellation keys from the head end 10 as to those contents which are prohibited from being watched (Step S35). A stand-by condition is maintained for those contents until the cancellation keys are provided (Step S36). When a cancellation key is supplied from the head end 10 for a certain content, the STB 41 activates that content (i.e., releases the movie) with the cancellation key and updates the title menu. As a result, the subscriber sees the new title in the title menu and can watch the content (Step S37). The content distributed by the pre-load service is now treated in the same way as the content acquired by the VOD service. The-subscriber is therefore able to watch the contents supplied via the pre-load service and VOD service in the same way.

As described above, the subscriber is simply required to connect the STB 41 with the existing TV 48 in order to watch free and pay TV programs, utilize the Internet service and watch movies. Further, the CATV operator 33 can readily provide subscribers with the VOD service without investing in preparing a communication network or line(s) of a large capacity.

The system only needs the ordinary Internet and the conventional CATV network. The system does not need any system renewal to the existing infrastructure.

Although the illustrated and described embodiment operates on the ordinary CATV service, the present invention is applicable to a wide variety of network configurations (structures). For example, the audio and video information providing system 1 can be directly coupled with a telephone network having a plurality of channels or a fiberoptic network having a plurality of channels.

This application is based on a Japanese patent application No. 2001-277001, and the entire disclosure thereof is incorporated herein by reference.

What is claimed is:

1. A system for providing one or more subscriber terminals with information comprising:
at least one subscriber terminal having a storage unit; and
a server for selecting one of a unicast and multicast scheme and sending information to the at least one subscriber terminal in the selected scheme, wherein each of the at least one subscriber terminal receives the information in a manner complying with the selected scheme and stores the information in the storage unit.

2. The system according to claim 1, wherein the server sends the information to a subscriber terminal in the unicast scheme when the subscriber terminal requests the information from the server; and the server sends the information to a plurality of subscriber terminals in the multicast scheme when the server voluntarily sends the information to the plurality of subscriber terminals.

3. The system according to claim 2, wherein the server cyclically sends the information to the plurality of subscriber terminals in the multicast scheme.

4. The system according to claim 3, wherein each of the at least one subscriber terminal determines whether there is a missing part in the information received, and requests the missing part from the server when the subscriber terminal determines that there is the missing part in the information received.

5. The system according to claim 4, wherein the server sends the missing part in the unicast scheme.

6. The system according to claim 5, wherein the information is audio and video information.

7. The system according to claim 6, wherein the storage unit is one of a once write type storage unit and a rewritable type storage unit.

8. The system according to claim 7, wherein the information to be sent to the plurality of subscriber terminals includes a plurality of titles.

9. The system according to claim 8, wherein the server updates at least one title of the plurality of titles at predetermined intervals.

10. The system according to claim 1, wherein the server encrypts the information and sends the encrypted information to the at least subscriber terminal.

11. The system according to claim 10, wherein the server sends a decryption key to the at least subscriber terminal at a predetermined time.

12. The system according to claim 10, wherein the server sends the encrypted information in the multicast scheme.

13. The system according to claim 1, wherein each of the at least one subscriber terminal has a self diagnosis function and informs the server of a result of self diagnosis.

14. An apparatus for providing at least one subscriber terminal with information comprising:
a server for sending the information to the at least one subscriber terminal in one of a unicast and multicast scheme, wherein the at least one subscriber terminal receives the information in a manner complying with the selected scheme.

15. The apparatus according to claim 14, wherein the server sends the information to a subscriber terminal in the unicast scheme when the subscriber terminal requests the information from the server; and the server sends the information to a plurality of subscriber terminals in the multicast scheme when the server voluntarily sends the information to the plurality of subscriber terminals.

16. The apparatus according to claim 15, wherein the server cyclically sends the information to the plurality of subscriber terminals in the multicast scheme.

17. The apparatus according to claim 16, wherein the server supplies a missing part of the information upon request from a subscriber terminal.

18. The apparatus according to claim 17, wherein the information is audio and video information.

19. The apparatus according to claim 18, wherein the server encrypts the information and sends the encrypted information to the at least subscriber terminal.

20. The apparatus according to claim 19, wherein the server sends a decryption key to the at least subscriber terminal at a predetermined time.
